(19) United States
(12) Patent Application Publication
(10) Pub. No.: US 2012/0086896 A1
(43) Pub. Date: Apr. 12, 2012

(54) LIQUID CRYSTAL DISPLAY DEVICE

(75) Inventor: Kazuyoshi TANAKA, Mobara (JP)

(73) Assignees: Panasonic Liquid Crystal Display Co., Ltd.; Hitachi Displays, Ltd.

(21) Appl. No.: 13/252,502

(22) Filed: Oct. 4, 2011

(30) Foreign Application Priority Data
Oct. 8, 2010 (JP) 2010-228203

(51) Int. Cl. G02F 1/1335

(52) U.S. Cl. 349/112

(57) ABSTRACT

A liquid crystal display device includes a diffuser plate which diffuses light, support members which support the diffuser plate, and a liquid crystal panel on which diffused light is incident. The support members each include a placement surface on which the diffuser plate is placed, a first connected surface connected in a slanted manner to an end section of the placement surface, among two end sections of the placement surface that face each other in a width direction, and a second connected surface connected to one of the end sections. A synthetic resin film is glued seamlessly across the placement surface, the first connected surface and the second connected surface via an adhesive layer provided on one surface of the synthetic resin film. The synthetic resin film has a smaller frictional coefficient with respect to the diffuser plate than the placement surface.

### CLAIM OF PRIORITY

The present application claims priority from Japanese Patent Application JP 2010-228203 filed on Oct. 8, 2010, the content of which is hereby incorporated by reference into this application.

### BACKGROUND OF THE INVENTION

1. Field of the Invention

The present invention relates to a liquid crystal display (LCD) device in which light is radiated to its liquid crystal panel in a diffused manner through a diffuser plate.

2. Description of the Related Art

In such an LCD device, the base section of its diffuser plate is typically made of resin. Thus, such an LCD device is often designed such that the diffuser plate is supported in a stretchable manner, based on the consideration of how much the diffuser plate may expand or contract due to the heat of the light source. For example, in the LCD devices disclosed in JP-A-2008-52114 and JP-A-2009-63903, support members sandwich a diffuser plate in a thickness direction of that plate, and clearances are provided in a direction perpendicular to a plate thickness direction, so that the diffuser plate can be supported in a stretchable manner.

### SUMMARY OF THE INVENTION

Typically, a diffuser plate has micro-irregularities on its resin surface with which support members come into contact. Because the diffuser plate is formed by pouring resin into a mold, it also has irregularities attributable to the joint of the mold. Thus, when the diffuser plate and support members are rubbed against each other, it is highly likely that dust particles will occur.

The problem with the LCD devices of JP-A-2008-52114 and JP-A-2009-63903 is that the friction between the support members and diffuser plate may cause dust particles since the diffuser plate is supported in a stretchable manner by the support members. Such dust particles may eventually enter the display area of the display screen, causing display screen abnormalities.

The present invention has been contrived to address the above problem, and an object of the invention is to provide a liquid crystal display device that reduces the chances of display screen abnormalities attributable to the occurrence of dust particles within the device.

To solve the above problem and achieve the above object, the present invention is a liquid crystal display device comprising: a diffuser plate which diffuses light; support members which support the diffuser plate; and a liquid crystal panel on which the diffused light from the diffuser plate is incident, wherein the support members each include: a placement surface on which the diffuser plate is placed; a first connected surface connected in a slanted manner to one of two end sections of the placement surface that face each other in a width direction of the placement surface; and a second connected surface connected to the other of the two end sections of the placement surface. Further, a synthetic resin film is glued seamlessly across the placement surface, the first connected surface, and the second connected surface via an adhesive layer provided on one surface of the synthetic resin film, and the synthetic resin film has a smaller frictional coefficient with respect to the diffuser plate than the placement surface.

In the LCD device described above, the second connected surface is connected to the placement surface from below such that a direction normal to the second connected surface is perpendicular to a direction normal to the placement surface.

Alternatively, in the LCD device described above, the second connected surface is connected to the placement surface from above such that a direction normal to the second connected surface is perpendicular to a direction normal to the placement surface.

Preferably, in the LCD device described above, the synthetic resin film is made from polyethylene terephthalate.

Preferably, in the LCD device described above, a reflective sheet is glued via an adhesive layer to the part of the synthetic resin film that is glued to the first connected surface.

As above, the LCD device of the present invention has a synthetic resin film glued seamlessly, via an adhesive layer, across not only the placement surface of each support member but also across the two surfaces connected to the two mutually-facing end sections of the placement surface. This prevents the synthetic resin film from being displaced from the placement surface. Even if the film is displaced from the placement surface toward either of the mutually-facing end sections of the placement surface, the part of the film that is glued to the opposite end section is also displaced in such a way as to cover the placement surface, thereby preventing the placement surface from being exposed. Thus, the presence of the friction-reducing synthetic resin film between the support members and the diffuser plate prevents the occurrence of dust particles due to the friction between the support members and the diffuser plate. This reduces the chances of display screen abnormalities attributable to the occurrence of dust particles within the LCD device.

### BRIEF DESCRIPTION OF THE DRAWINGS

FIG. 1 is an exploded perspective view illustrating the configuration of an LCD device according to Embodiment 1 of the invention;

FIG. 2 is an enlarged perspective view of the illuminator unit of FIG. 1;

FIG. 3 is a cross section of the illuminator unit taken from line A-A of FIG. 2;

FIG. 4 is an enlarged perspective view of one of the side molds of FIG. 1;

FIG. 5 is a perspective view illustrating the back side of the side mold of FIG. 4;

FIG. 6 is a diagram illustrating a modification of Embodiment 1 of the invention; and

FIG. 7 is a perspective view illustrating the configuration of the illuminator unit of an LCD device according to Embodiment 2 of the invention.

### DESCRIPTION OF THE PREFERRED EMBODIMENTS

Liquid crystal display (LCD) devices according to preferred embodiments of the present invention will now be described in detail with reference to the accompanying drawings.

### Embodiment 1

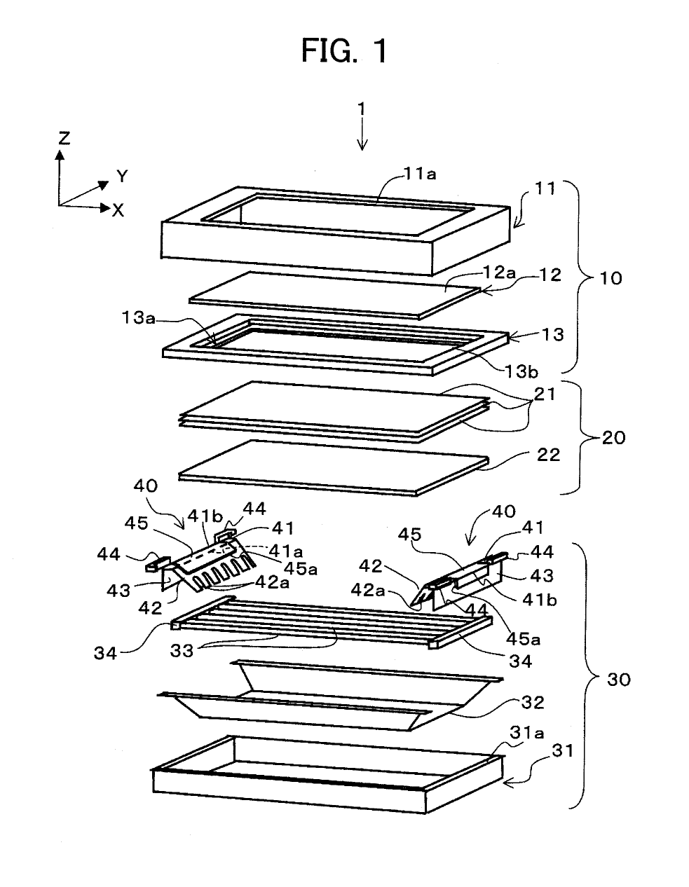

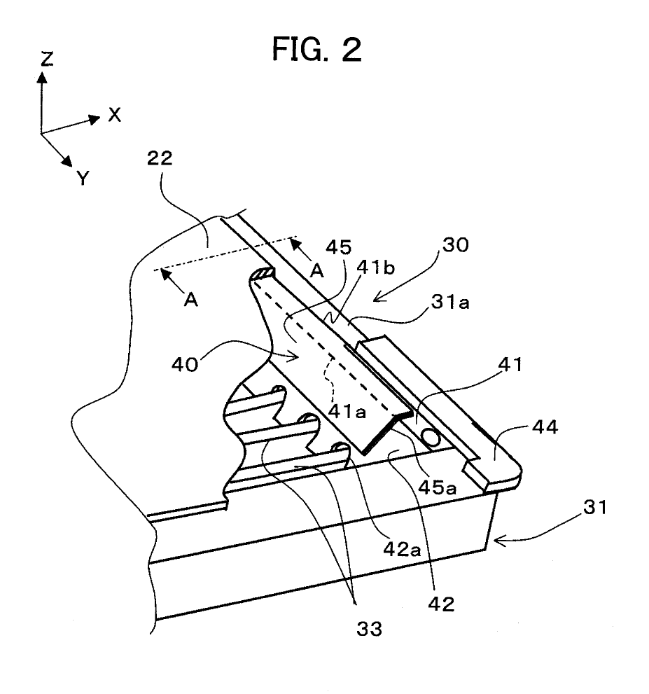

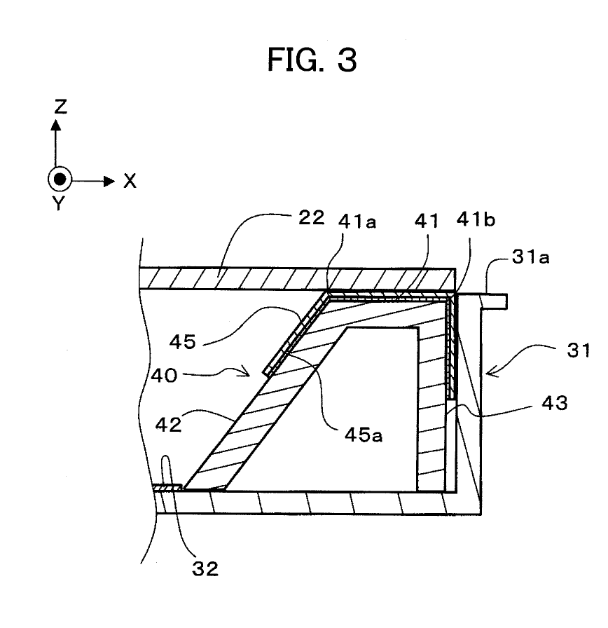

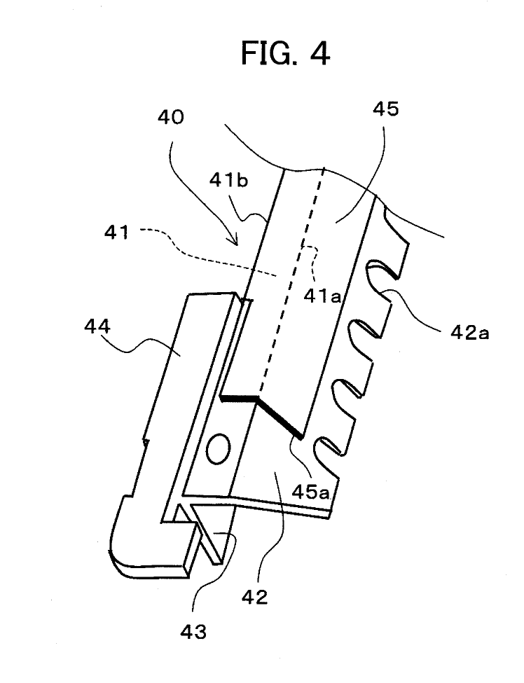

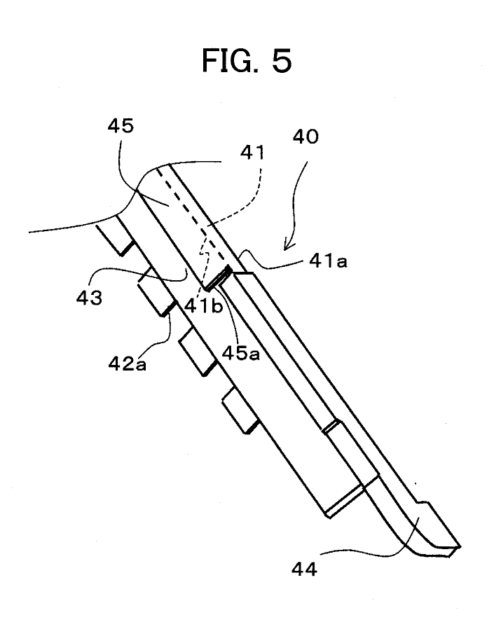

FIG. 1 is a schematic illustrating the configuration of an LCD device 1 according to Embodiment 1 of the invention. FIG. 2 is an enlarged perspective view of the illuminator unit 30 of FIG. 1. FIG. 3 is a cross section of the illuminator unit 30 taken from line A-A of FIG. 2. FIG. 4 is an enlarged perspective view of one of the side molds 40 of FIG. 1. FIG. 5 is a perspective view illustrating the back side of the side mold 40 of FIG. 4. As illustrated in FIG. 1, the LCD device 1 includes a display unit 10, a diffuser unit 20, and the illuminator unit 30. Note that in FIGS. 1 to 3, the X-axis represents a transverse direction of a liquid crystal panel 12, the Y-axis a longitudinal direction of the panel 12, and the Z-axis a direction normal to an X-Y plane. Note further that the illuminator unit 30 is often called a backlight, and that the illuminator unit 30 with the diffuser unit 20 is often called a backlight unit or simply a backlight.

The display unit 10 displays still or motion images on the display surface 12a of the liquid crystal panel 12. The display unit 10 includes an upper frame 11, the liquid crystal panel 12, and a middle frame 13.

The upper frame 11 is made of metal such as iron and aluminum and designed to partially cover the front surface of the LCD device 1. The upper frame 11 has a rectangular opening 11a so that the display surface 12a of the liquid crystal panel 12 can be exposed.

The liquid crystal panel 12 is designed to change the transmittance of the light from the illuminator unit 30 for each pixel, the smallest unit by which liquid crystals form an image, thereby displaying still or motion images on the display surface 12a. For example, the liquid crystal panel 12 has electrodes arranged on glass substrates in the form of a lattice, and these electrodes control an electric field to change the orientation of the liquid crystal molecules, thereby allowing the liquid crystal panel 12 to transmit or block light on a pixel-by-pixel basis.

The middle frame 13 is a frame to which the liquid crystal panel 12 is fixed. The middle frame 13 is made of resin and has an opening 13b formed at the position corresponding to that of the opening 11a of the upper frame 11 so that the light radiated from the illuminator unit 30 can be directed toward the liquid crystal panel 12 through the opening 13b. The middle frame 13 also has a groove 13a formed on it that surrounds the opening 13b. The liquid crystal panel 12 is fitted in the groove 13a and thereby fixed to the middle frame 13. The middle frame 13 is fitted within the inner walls of the upper frame 11.

The diffuser unit 20 is located between the display unit 10 and the illuminator unit 30 and designed to direct the light emitted from the illuminator unit 30 toward the liquid crystal panel 12 in a diffused manner. In other words, before the light emitted from the illuminator unit 30 reaches the liquid crystal panel 12, the diffuser unit 20 diffuses the light, thereby achieving a uniform luminance distribution. This allows the display surface 12a of the liquid crystal panel 12 to display images with less luminance unevenness. The diffuser unit 20 includes an optical sheet 21 and a diffuser plate 22.

The optical sheet 21 allows the light emitted from the illuminator unit 30 to pass through it in a diffused manner, thereby achieving a uniform luminance distribution. The optical sheet 21 is a laminate of three optical sheets so that the sheet 21 can repeat the diffusion and reflection of the light emitted from illuminator unit 30 before the light reaches the liquid crystal panel 12. This allows the light emitted from the illuminator unit 30 to have a uniform luminance distribution across the liquid crystal panel 12. It should be noted that while the optical sheet 21 of this embodiment is a laminate of three optical sheets, it is also possible to stack a desired number (not limited to three) of optical sheets to form the optical sheet 21.

The diffuser plate 22 is made of transparent synthetic resin such as methyl methacrylate-styrene copolymer resin and the like and supports the optical sheet 21. The optical sheet 21 is glued to this diffuser plate 22.

The illuminator unit 30 irradiates the liquid crystal panel 12 with light and includes the following components: a lower frame 31; a reflective sheet 32; fluorescent tubes 33; electrode units 34; and side molds 40.

The lower frame 31 is a box-shaped chassis and has an opening that faces a +Z direction. The lower frame 31 houses all the components of the illuminator unit 30 mentioned above (i.e., the reflective sheet 32; the fluorescent tubes 33; the electrode units 34; and the side molds 40).

The reflective sheet 32 is disposed so as to face the liquid crystal panel 12 with the fluorescent tubes 33 placed in between, so that the light emitted from the fluorescent tubes 33 can efficiently be reflected in a diffused manner in a +Z direction. The reflective sheet 32 is made of synthetic resin and preferably made of a white synthetic resin sheet. The light emitted from the fluorescent tubes 33 is diffused and reflected in a repeated manner between the reflective sheet 32 and the diffuser plate 22 before the light reaches the liquid crystal panel 12.

The fluorescent tubes 33 are linear light sources such as CCFLs (Cold-Cathode Fluorescent Lamps) and the like. The fluorescent tubes 33 serves as light sources for the liquid crystal panel 12 by emitting white light. The electrode units 34 are used to fix both ends of the fluorescent tubes 33 and to supply electric power to the tubes 33.

The side molds 40 are made of synthetic resin, and their outer surfaces reflect the light emitted from the fluorescent tubes 33. The side molds 40 are made of polycarbonate, for example. Each of the side molds 40 is located at the inner end of the lower frame 31 in a transverse direction and covers one of the electrode units 34 from above, thereby increasing the light reflection by that region toward the diffuser unit 20. The side molds 40 support the diffuser unit 20 in a stretchable manner by the diffuser unit 20 being sandwiched between the side molds 40 and the middle frame 13. The side molds 40 are fixed to the lower frame 31 via screws or the like.

The LCD device 1 also includes a control unit, not illustrated, for controlling the liquid crystal panel 12 or the illuminator unit 30. This control unit includes, for example, a computer having a CPU (Central Processing Unit), a RAM (Random Access Memory), a ROM (Read Only Memory); programs; peripheral circuits having gate and drain drivers; and a timing controller.

The side molds 40 will now be described in greater detail. As illustrated in FIGS. 4 and 5, the side molds 40 each include a placement surface 41, a slanted surface 42, a vertical surface 43, and two diffuser plate guides 44.

The placement surface 41 is the surface on which the diffuser plate 22 is placed. The slanted surface 42 is connected to the placement surface 41 as a first connected surface. This slanted surface 42 is connected in a slanted manner to the end section 41a of the placement surface 41, among the two end sections 41a and 41b of the placement surface 41 that face each other in a width direction (i.e., in an X-direction). The slanted surface 42 is inclined such that the slanted surface 42 gets closer to the liquid crystal panel 12 as it gets closer to the transverse end of the lower frame 31 at which the side mold 40 having this slanted surface 42 is located. In addition, the distal end of the slanted surface 42 is in contact with the reflective sheet 32, but at the same time has substantially semicircular notches 42a so that the slanted surface 42 will not touch the fluorescent tubes 33.

The vertical surface 43 is connected to the placement surface 41 as a second connected surface. Among the two mutually-facing end sections 41a and 41b of the placement surface 41, the vertical surface 43 is connected to the end section 41b, opposite the end section 41a to which the slanted surface 42 is connected. The vertical surface 43 is connected to the placement surface 41 from below such that a direction normal to the vertical surface 43 is perpendicular to a direction normal to the placement surface 41.

As partially illustrated in FIG. 2, four diffuser plate guides 44 are placed on the outer edges 31a of the lower frame 31 and designed to surround the four corners of the diffuser plate 22. One diffuser plate guide 44 is placed on each Y-directional end section of one side mold 40 (hence four diffuser plate guides 44 in total). Both of the diffuser plate guides 44 and the diffuser plate 22 are sandwiched between the lower frame 31 and the middle frame 13.

Each of the side molds 40 also has a synthetic resin film 45 glued to it. This synthetic resin film 45 is made from polyethylene terephthalate. As also illustrated in FIGS. 2 to 5, an adhesive layer 45a is formed on one surface of the resin film 45. Further, the synthetic resin film 45 has flatter surfaces with fewer irregularities than the placement surface 41; thus, the frictional coefficient of each side mold 40 with respect to the diffuser plate 22 is smaller than that of the placement surface 41. It should be noted that any material other than polyethylene terephthalate can instead be used to from the synthetic resin film 45 as long as it is a synthetic resin whose frictional coefficient with respect to the diffuser plate 22 is smaller than that of the placement surface 41.

The adhesive layer 45a of the synthetic resin film 45 is made, for example, from urethane resin-based adhesive. Other adhesives can also be used to form the adhesive layer 45a; examples include acrylic resin-based adhesive, rubber-based adhesive, silicone-based adhesive, and epoxy resin-based adhesive.

As illustrated in FIGS. 3 to 5, the synthetic resin film 45 is glued seamlessly across not only the placement surface 41 but also across the slanted surface 42 and the vertical surface 43 (i.e., the first and second connected surfaces connected to the end sections 41a and 41b, respectively, of the placement surface 41 that face each other in a width direction). This prevents the synthetic resin film 45 from being displaced from the placement surface 41 even when the heat of the fluorescent tubes 33 causes the adhesive of the synthetic resin film 45 to become soft or causes the side molds 40 to expand or contract.

In addition, even when the synthetic resin film 45 is displaced toward the end section 41a, it is pulled back toward the placement surface 41 because the part of the film 45 that is glued to the vertical surface 43 connected to the opposite end section 41b is pulled. Conversely, even when the synthetic resin film 45 is displaced toward the end section 41b, it is pulled back toward the placement surface 41 because the part of the film 45 that is glued to the slanted surface 42 connected to the opposite end section 41a is pulled.

As above, the LCD device 1 of Embodiment 1 has a synthetic resin film 45 glued seamlessly across not only the placement surface 41 of each side mold 40 but also across the slanted surface 42 and the vertical surface 43, that is, the first and second connected surfaces connected to the end sections 41a and 41b, respectively, of the placement surface 41 that face each other in a width direction. This prevents the part of the synthetic resin film 45 that is glued to the placement surface 41 from being displaced therefrom. Even if the film 45 is displaced from the placement surface 41 toward either of the mutually-facing end sections, 41a or 41b, of the placement surface 41, the part of the film 45 that is glued to the opposite end section is also displaced in such a way as to cover the placement surface 41, thereby preventing the placement surface 41 from being exposed. Thus, the presence of the friction-reducing synthetic resin film 45 between the side molds 40 and the diffuser plate 22 prevents the occurrence of dust particles due to the friction between the side molds 40 and the diffuser plate 22. This reduces the chances of display screen abnormalities attributable to the occurrence of dust particles within the LCD device.

### Modification

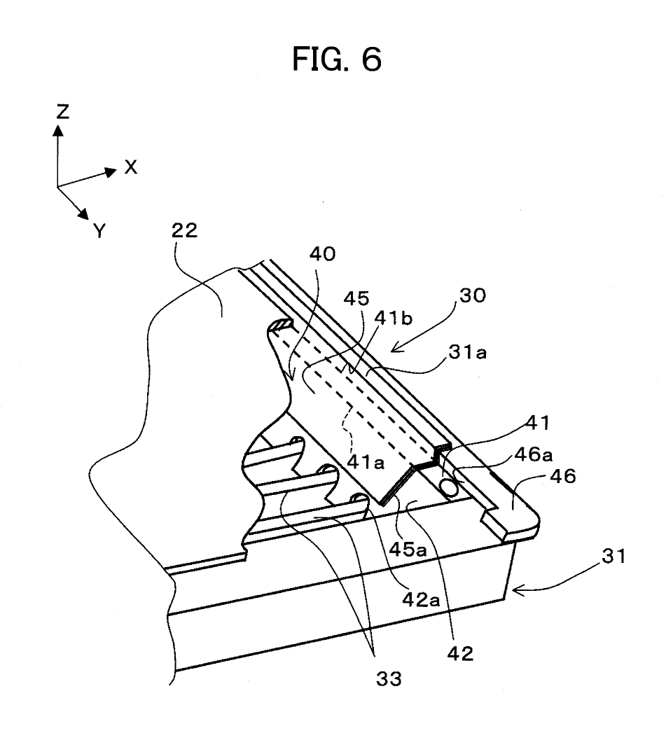

With reference now to FIG. 6, a modification of Embodiment 1 of the invention is described. FIG. 6 illustrates this modification.

In Embodiment 1 described above, a synthetic resin film 45 is glued seamlessly across the placement surface 41, the slanted surface 42, and the vertical surface 43 of each side mold 40. In this modification, by contrast, a synthetic resin film 45 is glued not to the vertical surface 43 but to a surface 46a of a diffuser plate guide 46. This surface 46a is connected to the placement surface 41 from above such that a direction normal to the surface 46a is perpendicular to a direction normal to the placement surface 41.

In this modification, therefore, a seamless synthetic resin film 45 is glued across the placement surface 41, the slanted surface 42, and the surface 46a of each side mold 40, which leads to the same advantages of Embodiment 1. Note that, in this modification, one diffuser plate guide 46 is provided from one Y-directional end to the other Y-directional end of each side mold 40.

### Embodiment 2

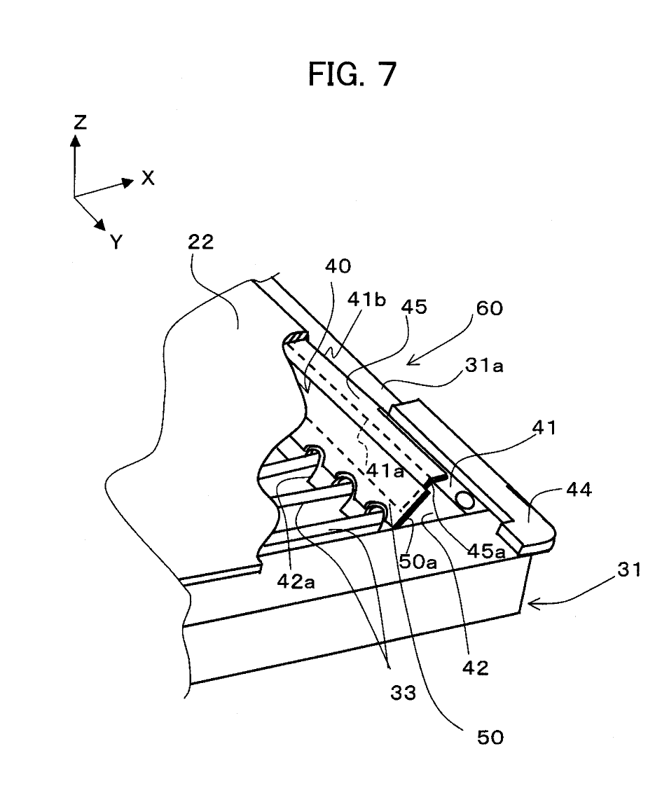

Embodiment 2 of the present invention will now be described with reference to FIG. 7. FIG. 7 is a perspective view illustrating the configuration of the illuminator unit 60 of an LCD device according Embodiment 2 of the invention.

When a synthetic resin film 45 is glued to the slanted surface 42 of each side mold 40 as with the LCD device 1 of Embodiment 1, this may result in reduction of the light reflectance of the area to which the film 45 is glued, thus reducing the luminance of the display screen.

In such a case, it is necessary to increase the reflection of light by the side molds 40. Thus, the LCD device of Embodiment 2 has a reflective sheet 50 glued to each synthetic resin film 45 via an adhesive layer 50a.

Specifically, as illustrated in FIG. 7, a synthetic resin sheet 45 is glued seamlessly across the placement surface 41, the slanted surface 42, and the vertical surface 43 of each side mold 40, and a reflective sheet 50 is glued to the part of the synthetic resin film 45 that is glued to the slanted surface 42. The reflective sheet 50 has a reflectance just high enough not to decrease the luminance of the display screen.

The reflective sheet 50 is made of synthetic resin and preferably made of a white synthetic resin sheet as with the reflective sheet 32. Also, the adhesive layer 50a is made, for example, from urethane resin-based adhesive, acrylic resin-based adhesive, rubber-based adhesive, silicone-based adhesive, or epoxy resin-based adhesive, as with the adhesive layer 45a of Embodiment 1. The rest other than the above configuration is the same as in Embodiment 1. Note that in FIG. 7, the same reference numerals as those used in the other figures denote identical components.

In Embodiment 2 described above, a seamless synthetic resin film 45 is glued across the placement surface 41, the slanted surface 42, and the vertical surface 43 of each side mold 40, which leads to the same advantages of Embodiment 1. Moreover, since a reflective sheet 50 is glued to the part of a synthetic resin film 45 that is glued to the slanted surface 42 of each side mold 40, it is possible to prevent the luminance of the display screen from decreasing.

It is to be noted that the present invention is not limited to the embodiments described above.

What is claimed is:

1. A liquid crystal display device comprising:
a diffuser plate which diffuses light;
support members which support the diffuser plate; and
a liquid crystal panel on which a diffused light from the diffuser plate is incident,
wherein the support members each include:
a placement surface on which the diffuser plate is placed;
a first connected surface connected in a slanted manner to one of two end sections of the placement surface that face each other in a width direction of the placement surface; and
a second connected surface connected to the other of the two end sections of the placement surface, and
wherein a synthetic resin film is glued seamlessly across the placement surface, the first connected surface, and the second connected surface via an adhesive layer provided on one surface of the synthetic resin film, the synthetic resin film having a smaller frictional coefficient with respect to the diffuser plate than the placement surface.

2. The liquid crystal display device of claim 1, wherein the second connected surface is connected to the placement surface from below such that a direction normal to the second connected surface is perpendicular to a direction normal to the placement surface.

3. The liquid crystal display device of claim 1, wherein the second connected surface is connected to the placement surface from above such that a direction normal to the second connected surface is perpendicular to a direction normal to the placement surface.

4. The liquid crystal display device of claim 1, wherein the synthetic resin film is made from polyethylene terephthalate.

5. The liquid crystal display device of claim 1, wherein a reflective sheet is glued via an adhesive layer to the part of the synthetic resin film that is glued to the first connected surface.
